(19) United States
(12) Patent Application Publication
(10) Pub. No.: US 2026/0008043 A1
(43) Pub. Date: Jan. 8, 2026

(54) A CATALYST FOR GENERATING HYDROGEN AND METHOD OF ITS PRODUCTION

(71) Applicant: Electriq-Global Energy Solutions Ltd., Tirat Carmel (IL)

(72) Inventors: Baruch Halpert, Tirat Carmel (IL); Shany Hershkovitz-Yaakobov, Haifa (IL); Yaara Shaham, Haifa (IL); Karina Gravilenko (Krasnov), Haifa (IL); Asher Adler, Haifa (IL)

(21) Appl. No.: 18/862,093

(22) PCT Filed: May 1, 2023
(86) PCT No.: PCT/IL2023/050439

§ 371 Date: Oct. 31, 2024

(30) Foreign Application Priority Data
May 1, 2022 (IL) 292647

(51) Int. Cl. B01J 37/34; B01J 19/24; B01J 23/75; B01J 27/185; B01J 37/02; C01B 3/06; C25D 3/12

(52) U.S. Cl. CPC B01J 37/348; B01J 19/24; B01J 23/75; B01J 27/1853; B01J 37/0244; C01B 3/065; C25D 3/12

(57) ABSTRACT

The present disclosure provides a catalyst, its preparation and uses thereof, the catalyst comprising a conductive substrate coated by at least two layers including a proximal layer and a distal layer wherein said proximal layer comprises a proximal metal composition and said distal layer comprise a distal metal composition, the proximal metal composition being different from the distal metal composition; wherein said proximal metal composition comprises a metallic M and said distal metal composition comprise a combination of two or more different metal complexes, each having a formula MₓL_{y}, wherein M, which may be the same or different in said two or more metal complexes, represents a metal atom; L, which may be the same or different in said two or more metal complexes, represents a moiety comprising at least one atom selected from the group consisting of oxygen (O), phosphorous (P), boron (B) and nitrogen (N); x represents any value between (1) and (6); and y represents any value between (1) and (6); and wherein said metal atom of metallic M and said metal atom in MₓL_{y} may be the same or different metal atom.

### RELATED APPLICATIONS

The present application is a national phase filing under 35 USC 371 of International Application No. PCT/IL2023/050439, filed May 1, 2023, which claims priority of Israeli Patent Application No. 292647, filed on May 1, 2022, the contents of both of which are incorporated herein in their entirety for all purposes.

### TECHNOLOGICAL FIELD

The present disclosure relates to a catalyst and specifically to a catalyst for generating hydrogen.

### BACKGROUND ART

References considered to be relevant as background to the presently disclosed subject matter are listed below:
International Patent Application Publication No. WO 2016/139669
US Patent Application Publication No. 2009/019682
US Patent Application Publication No. 2006/0293173

Acknowledgement of the above references herein is not to be inferred as meaning that these are in any way relevant to the patentability of the presently disclosed subject matter.

### BACKGROUND

Hydrogen has attracted attention in the past decades as a source for clean energy production, envisioned to be utilized in fuel cells due to its capability to release energy with high efficiency through electro-oxidation reactions. Conventional hydrogen energy conversion systems are typically based on hydrogen storage in the form of pressurized molecular hydrogen, liquefied hydrogen, carbonaceous materials, and as atomic hydrogen in metal hydrides.

Various catalysts have been developed for generating hydrogen gas from aqueous metal borohydride fuel solutions by hydrolysis reaction. Typical catalysts known in the art are ruthenium, rhodium and platinum-based, which are relatively expensive, thereby increasing the costs of the hydrogen generating systems comprising them. Other known catalysts are organometallic complexes.

Activity, durability, and cost of the catalyst are a major barrier for meeting commercial specifications. Improvements in catalyst activity would enable higher reactor throughput, therefore reducing the required total volume of catalyst, and consequently the static liquid hold-up volume of the hydrogen generation system. A durable catalyst must ensure that such high throughput is maintained over a relatively long period of time, thus eliminating the need to over-design the amount of catalyst used to compensate for the reduced activity of the aged catalyst.

International Patent Application Publication No. WO 2016/139669 is directed to a process for production a metal-borohydride decomposition catalyst, the process comprising depositing an alloy onto a surface of a cathode, the deposition being carried out in a solution under induced constant cathode potential.

US Patent Application Publication No. 2009/019682 is directed to a catalyst-coated nickel template comprising an open-cell nickel foam having within it pores defined by an internal nickel surface, the foam also having an external nickel surface not within the pores, and a layer of catalyst comprising Co and B on at least a portion of the internal nickel surface and at least a portion of the external nickel surface, and method for production thereof.

US Patent Application Publication No. 2006/0293173 is directed to a supported metallic catalyst comprising a support substrate carrying a mixture of a first transition metal and a second component selected from the group consisting of cobalt, ruthenium, zinc, molybdenum, manganese, iron, boron, titanium, tin, cadmium, nickel, and iridium.

### SUMMARY OF INVENTION

The present disclosure provides, in accordance with a first of its aspects, a catalyst for hydrogen generating. Specifically, there is provided a catalyst comprising a conductive substrate coated by at least two layers including a proximal layer and a distal layer,
wherein said proximal layer comprises a proximal metal composition and said distal layer comprises a distal metal composition, the proximal metal composition being different from the distal metal composition;
wherein said proximal metal composition comprise a metallic M and said distal metal composition comprise a combination of two or more different metal complexes, each having a formula MₓL_{y}, wherein
M, which may be the same or different in said two or more metal complexes, represents a metal atom;
L, which may be the same or different in said two or more metal complexes, represents a moiety comprising at least one atom selected from the group consisting of oxygen (O), phosphorous (P), boron (B) and nitrogen (N);
x represents any value between 1 and 6; and
y represents any value between 1 and 6; and
wherein said metal atom of metallic M and said metal atom in MₓL_{y} may be the same or different metal atom.

Also provided by the present disclosure is a process for producing a catalyst for hydrogen production. The process comprises:
providing an electrochemical cell comprising a cathode and an anode, each being connected to an electrical source, said cathode comprising a conductive substrate;
expositing said electrochemical cell to a first electrolyte solution comprising a metal M salt and a counter ion salt, said first electrolyte solution having an acidic pH; and
operating said electrochemical cell under first conditions that cause deposition of a proximal layer over said conductive substate, the proximal layer comprising at least metallic M;
expositing said electrochemical cell having said proximal layer on said substrate, to a second electrolyte solution having an alkaline pH and comprising a metal salt and a counter ion salt, which may be the same or different from the metal salt and the counter ion salt of said first electrolyte solution; and operating the electrochemical cell under second conditions that cause deposition of a distal layer over said proximal layer, the distal layer coating comprising a combination of two or more different metal complexes, each having a formula MₓL_{y}, wherein
M, which may be the same or different in said two or more metal complexes, represents a metal atom;
L, which may be the same or different in said two or more metal complexes, represents a moiety comprising at least one atom selected from the group consisting of oxygen (O), phosphorous (P), boron (B) and nitrogen (N);
x represents any value between 1 and 6; and
y represents any value between 1 and 6;
said catalyst comprises said conductive substrate coated with said proximal layer and said distal layer.

Further, there is provided by the present disclosure a system for generating and releasing hydrogen gas from a hydrogen carrier, the system comprising a reaction chamber carrying one or more catalysts as disclosed herein, a liquid inlet port connectable to a hydrogen carrier source and a gas outlet port for removing hydrogen gas released within the reaction chamber.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which

FIGS. 1A-1B are schematic illustrations of possible current density deposition profiles for preparing the proximal layer (FIG. 1A) and distal layer (FIG. 1B) of the different catalysts, referred to as Catalyst A, B, C, D, E, F or G, under the different indicated current density conditions.

FIGS. 2A-2C are images of Catalyst B including scanning electron microscopy (SEM) at a magnification of 1,000 (Energy 10 keV) (FIG. 2A); or at a magnification of 10,000 (FIG. 2B), the arrows indicating the different cracks, and a 3D profilometer image (FIG. 2C).

FIGS. 3A-3C are images of Catalyst C including SEM at magnification of 1,000 (Energy 10 keV); or at a magnification of 10,000, (Energy 5 keV) (FIG. 3B); and a 3D profilometer image.

FIGS. 4A-4G are SEM images of a top view of Catalyst F at different magnifications of 1,000 (Energy 5 keV) (FIG. 4A) and 10,000 (Energy 5 keV) (FIG. 4B), and cross-sectional view at a magnification of 3,000 (Energy 20 keV), of Catalysts D (FIG. 4C), E (FIG. 4D) and F (FIG. 4E) and cross section of Catalyst G in magnification ×2,000 (FIG. 4F) or magnification of ×8,000 (FIG. 4G).

FIGS. 5A-5D are graphs showing XPS (X-ray photoelectron spectroscopy) analysis of Catalyst F proximal layer and distal layer, and specifically showing the cobalt species spectra in its proximal layer (FIG. 5A), the phosphorous species spectra in its proximal layer (FIG. 5B), the cobalt species spectra in its distal layer (FIG. 5C) and the phosphorous species spectra in its distal layer (FIG. 5D).

FIGS. 6A-6B are graphs showing a comparison of the durability of catalyst A vs. Catalyst F (FIG. 6A) and of catalyst F vs. catalyst G (FIG. 6B).

### DETAILED DESCRIPTION

Catalysts are employed in various applications both in laboratories and in industry to mediated chemical reactions. Catalysts operate by providing an alternative reaction route, wherein the activation energy is lower route is not mediated by the catalyst.

The present disclosure is based on the development of a catalyst for generating hydrogen gas with improved, inter alia, mechanical stability and/or durability. The catalyst is based on the development of a technique allowing for a multi-layer coating of catalytic metal complexes over a conductive substrate. Surprisingly, it has been found that even after numerous hydrogen gas production cycles (runs), the catalyst maintained its integrity and functionality (no mechanical degradation was observed or detected) and was not affected by the mechanical stresses occurring during operation of a hydrogen-on-demand system.

In accordance with the current findings, the present disclosure provides, in accordance with a first of its aspect, a catalyst comprising a conductive substrate coated by at least two layers including a proximal layer and a distal layer,
wherein the proximal layer comprises a proximal metal composition and the distal layer comprises a distal metal composition, the proximal metal composition being different from the distal metal composition;
wherein said proximal metal composition comprises a metallic M and said distal metal composition comprises a combination of two or more different metal complexes, each having a formula MₓL_{y}, wherein
M, which may be the same or different in said two or more metal complexes, represents a metal atom;
L, which may be the same or different in said two or more metal complexes, represents a counter ion comprising at least one atom selected from the group consisting of oxygen (O), phosphorous (P), boron (B) and nitrogen (N);
x represents any value between 1 and 6, at times, a value between 1 and 5, at times, between 1 and 4, at times, between 1 and 3; and
y represents any value between 1 and 6; at times, a value between 1 and 5; at times, a value between 1 and 4; and
wherein said metal atom of metallic M and said metal atom in MₓL_{y} may be the same or different metal atom.

In the context of the present disclosure, when referring to a catalyst for generating hydrogen it is to be understood to encompass the disclosed catalytic structure exhibiting at least a catalytic effect on generating hydrogen gas from a solid inorganic hydrogen carrier (SIHC). The SIHC can be any chemical entity used in a hydrogen fuel cell. In some examples of the presently disclosed subject matter, the SIHC comprises M¹-BH₄ (metal borohydride in water), which can react in presence of the disclosed catalyst to produce hydrogen gas (H₂) and spent liquid carrier comprising M¹BO₂.

The catalyst comprises a conductive substrate. The conductive substrate can comprise any solid electrical conductor. In some examples of the presently disclosed subject matter, the conductive substrate includes at least one metal. Without being limited thereto, when the conductive substrate comprises a metal, the metal can be any one or combination of ferrous (Fe), Fe alloy, nickel (Ni), cobalt (Co), Ni/Co alloy, copper (Cu).

In some examples of the presently disclosed subject matter, the conductive substrate comprises stainless-steel conductive body.

In some examples of the presently disclosed subject matter, the conductive substrate comprises one or more metal containing layers sandwiched between the stainless-steel conductive body and the proximal layer comprising the proximal metal composition.

In some examples of the presently disclosed subject matter, the one or more metal containing, sandwiched, layers comprise a Ni-containing layer.

In some examples of the presently disclosed subject matter, the one or more metal containing, sandwiched, layers comprise a Cu-containing layer.

In some examples of the presently disclosed subject matter, the Ni-containing layer is in direct contact with the proximal layer comprising the proximal metal composition.

In some examples of the presently disclosed subject matter, the conductive substrate comprises a non-metallic conductive body. Without being limited thereto, when the conductive substrate is a non-metallic conductor, it may comprise any one or combination of carbon black and carbon paper.

In some examples of the presently disclosed subject matter, the conductive substrate comprises a combination of metallic conductive material and non-metallic conductive material.

The proximal layer comprising the proximal metal composition and the distal layer comprising the distal metal composition comprise each, independently, one or more chemical entities comprising a metal element “M”.

When referring to a chemical entity comprising a metal element “M” it is to be understood to refer to one or more chemical structures including at least one type of metal. The chemical structure can be a metallic M, i.e. a metal per se or a metal ion within a complex (typically, with the metal atom being positively charged). A layer can comprise different types of the chemical entities comprising the same or different metal element “M”.

The metal element can be any metal, however, in accordance with some examples, the metal “M” is selected from the group consisting of cobalt (Co), nickel (Ni), iron (Fe), ruthenium (Ru), rhodium (Rh), palladium (Pd), platinum (Pt), titanium (Ti), Vanadium (V), manganese (Mn), and Molybdenum (Mo).

In some examples of the presently disclosed subject matter, the metal element “M” is nickel (Ni).

In some examples of the presently disclosed subject matter, the metal element “M” is iron (Fe).

In some examples of the presently disclosed subject matter, the metal element “M” is manganese (Mn).

In some examples of the presently disclosed subject matter, the metal element “M” is Molybdenum (Mo).

Each layer can contain a single metal element M or different metals in different chemical forms (e.g. metallic M, metal salt, as further described below).

The composition of the proximal layer typically comprises at least metallic M (i.e. a metal in non-ionic/uncharged form). The presence of metallic M can be determined using X-ray photoelectron spectroscopy. In some examples of the presently disclosed subject matter, at least 50% of the proximal layer comprises one or more metals in non-ionic form (i.e. metallic M). In some examples of the presently disclosed subject matter, at least 60%, at times, at least 70%, at times, at least 80% or even 90% of the proximal layer comprises one or more metals in non-ionic form (i.e. metallic M). The amount of metallic M can be determined qualitatively or quantitatively, by means known to those versed in the art.

In some examples of the presently disclosed subject matter, the metal in the proximal layer is cobalt. Accordingly, the metallic M in the proximal layer is or comprises CoP.

The proximal layer and the distal layer can comprise, independently, one or more different metal complexes having the general formula MₓL_{y} as defined hereinabove and below.

In the context of the present disclosure it is to be understood that the term metal complex encompass the metal in charged/ionic forms. Thus, when referring to the metal complex, it does not include entities where the metal is in uncharged form (e.g. metallic M).

The M in the metal complex, MₓL_{y}, can be the same or different than that metallic M in the same layer.

Within a metal complex of formula MₓL_{y}, x broadly represents a value between 1 and 6. As such, x can be any value between 1 and 5, or 1 and 4, or 1 and 3, or 1 and 2. In some examples of the presently disclosed subject matter, x is any integer selected from 1, 2, 3, 4, 5, 6.

Further, within a metal complex of formula MₓL_{y}, y broadly represents a value between 1 and 6. As such, y can be any value between 1 and 5, or 1 and 4, or 1 and 3, or 1 and 2. In some examples of the presently disclosed subject matter, y is any integer selected from 1, 2, 3, 4, 5, 6.

It is to be noted that x and y can be the same or different within a complex.

In some examples of the presently disclosed subject matter, the composition of the proximal layer comprises in addition to the non-ionic metal, one or more metal of the complexes having the general formula MₓL_{y}.

When containing more than one type of the MₓL_{y} complex, the M element in the different complexes may be the same or different. In some examples of the presently disclosed subject matter, the M element in the two or more MₓL_{y} complexes within a layer is the same metal M.

In some examples of the presently disclosed subject matter, the proximal layer comprises metallic M and MₓL_{y} complexes, each having the same metal M.

Turning to the specific layers, in some examples of the presently disclosed subject matter, the metal complex in the proximal layer comprises cobalt. A non-limiting list of possible cobalt complexes within the proximal layer include at least one, at least two, at least three, at least four, cobalt complexes selected from the group consisting CoO, Co₂O₃, Co₃O₄, CoOOH, Co(OH)₂, CoPO₂, CoPO₄.

In some examples of the presently disclosed subject matter, the composition forming the proximal layer can comprise a combination of CoP and one or more of the aforesaid cobalt complexes. Yet, as noted above, in accordance with a preferred example, a majority of the proximal layer composition comprises CoP.

Turning now to the distal layer placed over the proximal layer, the distal layer may also comprise metallic M. Yet, in some examples of the presently disclosed subject matter, a majority of the distal layer comprises one or more metal complexes of the formula MₓL_{y} as defined hereinabove and below.

In some examples of the presently disclosed subject matter, the composition of the distal layer comprises two or more complexes of formula MₓL_{y}, with M being the same or different in the same distal layer.

In some examples of the presently disclosed subject matter, the distal layer comprises a single metal.

In some example of the presently disclosed subject matter s, the distal layer comprises cobalt as the sole metal.

In some examples of the presently disclosed subject matter, the distal layer comprises two or more, different, cobalt containing complexes of formula MₓL_{y}. In some examples of the presently disclosed subject matter, the distal layer comprises a combination of at least two, or at least three, or at least four complexes selected from the group consisting of CoO, Co₂O₃, Co₃O₄, CoOOH, Co(OH)₂, CoPO₂, CoPO₄.

The MₓL_{y} complex can also be characterized by the metal's counter ion, namely, the “L” moiety. In some examples of the presently disclosed subject matter, the counter ion “L” comprises phosphate P. This may include for example Co₂P, Mo₂P, Fe₂P, Ni₂P.

In some examples of the presently disclosed subject matter, the counter ion “L” comprises boron B. This may include, for example Co₂B.

In some examples of the presently disclosed subject matter, the counter ion “L” comprises nitrogen N.

In some examples of the presently disclosed subject matter, the counter ion “L” comprises oxygen O, such as in the cases described above with respect to cobalt.

In some examples of the presently disclosed subject matter, the distal and/or proximal layers comprise one or more metal complexes of formula MₓL_{y} where M is other than cobalt. Such other metal complexes may include, without being limited thereto, MoP, Mo₂P, FeP, Fe₂P, NiP, Ni₂P.

At times, the distal layer can also comprise (in addition to the metal complex(es)), metallic “M” per se. In some examples of the presently disclosed subject matter, the distal layer comprises CoP.

In some examples of the presently disclosed subject matter, the catalyst comprises an outer layer that can comprise the same or different composition of the distal layer.

In the context of the presently disclosed subject matter, the term “outer layer” is to be understood to refer to a layer placed over the distal layer. The outer layer can have the same of different composition form the distal layer. However, even if the composition is the same as that of the distal layer, the outer layer is always formed from a “fresh” electrolyte composition.

In some examples of the presently disclosed subject matter, the outer layer coating placed over the distal layer comprises one or more metal complexes of the formula MₓL_{y} as defined hereinabove and below with respect to the distal layer.

In some examples of the presently disclosed subject matter, the composition of the outer layer comprises two or more complexes of formula MₓL_{y}, with M being the same or different in the same distal layer.

In some examples of the presently disclosed subject matter, the outer layer comprises a single type metal.

In some examples of the presently disclosed subject matter, the outer layer comprises cobalt as the sole metal.

In some examples of the presently disclosed subject matter, the outer layer comprises two or more, different, cobalt containing complexes of formula MₓL_{y}.

In some examples of the presently disclosed subject matter, the outer layer comprises a combination of at least two, or at least three, or at least four complexes selected from the group consisting of CoO, Co₂O₃, Co₃O₄, CoOOH, Co(OH)₂, CoPO₂, CoPO₄.

In some examples of the presently disclosed subject matter, the outer layer has a cross sectional dimension that is shorter (smaller) than the cross-sectional dimension of the distal layer.

It has been found that the proximal layer and distal layer and when the distal layer is coated with an additional outer layer, the layers are distinguished one from the other not only in the metal compositions, but also in their morphology. While the proximal layer is a dense layer, the distal layer is porous in its nature. The further outer layer is thin and porous as visually observed in the SEM.

The dense morphology of the proximal layer can be determined or identified using scanning electron microscopy (SEM). For examples, when viewing a cross section cut of the catalyst (cut from the substrate to the distal coating layer), under SEM, with a magnification of 1,000 or more, the SEM image does not visualize gaps in the composition's mass. This is reflected in the non-limiting figures detailed below, all forming an integral part of the present disclosure.

The porous morphology of the distal layer can also be determined or identified using scanning electron microscopy (SEM). For examples, when viewing a cross section cut of the catalyst (cut from the substrate to the distal coating layer), under SEM, with a magnification of 1,000 or more, the SEM image clearly visualizes gaps between aggregates of matter.

In some examples of the presently disclosed subject matter, the aggregates of matter of the composition forming the distal layer have cauliflower shape, the gaps being formed between these aggregates. This is reflected in the non-limiting figures detailed below, all forming an integral part of the present disclosure.

The outer layer can be identified and distinguished from the distal layer by imaging, e.g. using SEM, as exemplified herein.

The catalyst disclosed herein demonstrated a beneficiary catalytic activity as determined using a Hydrogen-On-Demand (HOD) release system operated using 5M KBH₄ in H₂O.

When referring to a catalytic activity it is to be understood as the capability of the catalyst to catalyze the production of hydrogen gas in an HOD release system, as compared to the production rate, under the same conditions, in the absence of the catalyst.

“Hydrogen-On-Demand” (HOD) release systems are well known in the art and readily available. In some examples of the presently disclosed subject matter, the HOD release system employed by the present disclosure is as described in International Patent Application Publication No. WO 2019/202391, the content of which is incorporated herein, in its entirety, by reference.

In some examples of the presently disclosed subject matter, the catalytic activity is determined when the system is operated at elevated temperatures, e.g. above 50° C.; at times, above 60° C.; at times above 70° C.

In some examples of the presently disclosed subject matter, the catalytic activity is determined when the system is operated at elevated pressure, e.g. above 1 bars; at times, above 2 bars; at times above 3 bars; at times, above 4 bars, at times, above 5 bars, at times even at about 6 bars.

Thus, in the context of the presently disclosed subject matter, the catalyst can be defined as one having a statistically significant catalytic activity in generating hydrogen gas, as determined by a HOD release system in the presence of 5M KBH₄ in H₂O.

In some examples of the presently disclosed subject matter, the catalyst is characterized by its ability to maintain its structural and/or mechanical integrity being employed for hydrogen gas release for a period of at least 1 week; at times, a period of at least 2 weeks; at times, a period of at least 3 weeks; at times, a period of at least 4 weeks; at times, a period of at least 5 weeks; at times, a period of at least 6 weeks; at times, a period of at least 7 weeks; at times, a period of at least 8 weeks; at times, a period of at least 9 weeks; at times, a period of at least 10 weeks; at times, a period of at least 11 weeks; at times, a period of at least 12 weeks; at times, a period of at least 13 weeks; at times, a period of at least 14 weeks; at times, a period of at least 15 weeks.

In the context of the present disclosure, a maintain in integrity is confirmed when less than 10% of the catalysts' cross-sectional dimension (dimension crossing from the substrate to distal layer) is reduced after a defined period of time. The ability to maintain integrity after a defined period of time also characterize the durability of the catalyst.

The present disclosure also provides a process for producing a catalyst for hydrogen gas generation. In its broadest sense, the process comprises:
providing an electrochemical cell comprising a cathode and an anode, each being connected to an electrical source, the cathode comprising a conductive substrate of a type defined hereinabove;
expositing he electrochemical cell to a first electrolyte solution comprising a metal M salt and a counter ion salt, the first electrolyte solution having an acidic pH;
operating the electrochemical cell under first conditions that cause deposition of a metal containing layer comprising at least metallic M, over the conductive substate, the metal containing layer, being referred to herein as a proximal layer or undercoat within the formed catalyst;
expositing the electrochemical cell having the proximal layer on the substrate, to a second electrolyte solution having an alkaline pH and comprising a metal salt and a counter ion salt, which may be the same or different from the metal salt and the counter ion salt of the first electrolyte solution;
operating the electrochemical cell under second conditions that cause deposition of a layer over the proximal layer, the layer coating formed under the second conditions is referred to herein as a distal layer or coat within the formed catalyst and comprises at least a combination of two or more different metal complexes, each having a formula MₓL_{y}, as defined hereinabove.

In some examples, the process according to the presently disclosed subject matter comprises an additional coating step comprising expositing said electrochemical cell having said distal layer on said proximal layer, to a third electrolyte solution having an alkaline pH and comprising a metal salt and a counter ion salt, which may be the same or different from the metal salt and the counter ion salt of said second electrolyte solution; and operating the electrochemical cell under outer coating conditions that cause deposition of an outer layer over said distal layer, the outer layer coating comprising a combination of two or more different metal complexes, each having a formula MₓL_{y}, as defined herein.

For simplicity, throughout the above and below description, all definitions provided with respect to the second electrolyte solution, apply also for the third electrolyte solution.

In the context of the presently disclosed subject matter, the third electrolyte solution can be the same or different from the second electrolyte solution.

In the context of the disclosed process, it is to be understood that the conductive substrate, metal M, the counter ion, metallic M, metal complex MₓL_{y} all have the meanings as defined with respect to the catalyst.

In some examples of the presently disclosed subject matter, the first electrolyte solution, the second electrolyte solution and when used, the third electrolyte solution comprise, the same or different, metal salt.

In some examples of the presently disclosed subject matter, the first electrolyte solution and/or the second electrolyte solution and/or the third electrolyte solution comprise Cobalt (II) chloride hexahydrate (CoCl₂·6H₂O) and any other known cobalt salts.

In some examples of the presently disclosed subject matter, the first electrolyte solution and the second electrolyte solution and when used, the third electrolyte solution, have same counter ion salt(s).

In some examples of the presently disclosed subject matter, the first electrolyte solution and the second electrolyte solution, and when used, the third electrolyte solution, have different counter ion salt(s).

In some examples of the presently disclosed subject matter, the counter ion salt in the first electrolyte solution and/or the second electrolyte solution, and when used, in the third electrolyte solution, comprises or is a hypophosphite salt or hydrate.

When referring to a hypophosphite salt it is to be understood to encompass a salt selected from NaH₂PO₂ and KH₂PO₂ and hydrate thereof.

In some examples of the presently disclosed subject matter, the first electrolyte solution comprises at least one weak acid. In some examples of the presently disclosed subject matter, the weak acid is a weak Lewis acid. Without being limited thereto, the Lewis acid is H₃BO₃.

The first electrolyte solution has an acidic pH, i.e. a pH below 6.0. At times, the acidic pH is below 5.5; or below 5.0. In some examples of the presently disclosed subject matter, the first electrolyte solution has a pH between 3 and 6; at times, between 4 and 5.5.

In some examples of the presently disclosed subject matter, the pH of the first electrolyte solution is adjusted using a base, typically a strong base. A non-limiting example of a base that can be used for adjusting the pH is NaOH or KOH.

The second electrolyte solution has an alkaline pH that is at least above 8; at times, between 8 and 12; at times, between 8 and 11; at times between 8 and 10; at times, between 9 and 12; at times, between 9 and 11; at times between 9 and 10.

The first electrolyte solution and the second electrolyte solution can, independently, include a complexant (complexing agent), which may be the same or different. In the context of the present disclosure, the complexant is a substant that readily forms complexes with metals. In some examples of the presently disclosed subject matter, the complexant is an amino acid. In some examples of the presently disclosed subject matter, the complexant is glycine.

The electrochemical cell is exposed to the first electrolyte solution under first process conditions.

In some examples of the presently disclosed subject matter, the exposure of the electrochemical cell to the first electrolyte solution is under a constant current density.

In some examples of the presently disclosed subject matter, the exposure of the electrochemical cell to the first electrolyte solution is under a decreasing current density.

In some examples of the presently disclosed subject matter, the exposure of the electrochemical cell to the first electrolyte solution is under oscillating (or changing) current densities.

The electrochemical cell is exposed to the second electrolyte solution under second process conditions.

In some examples of the presently disclosed subject matter, the exposure of the electrochemical cell to the second electrolyte solution is under a decreasing current density.

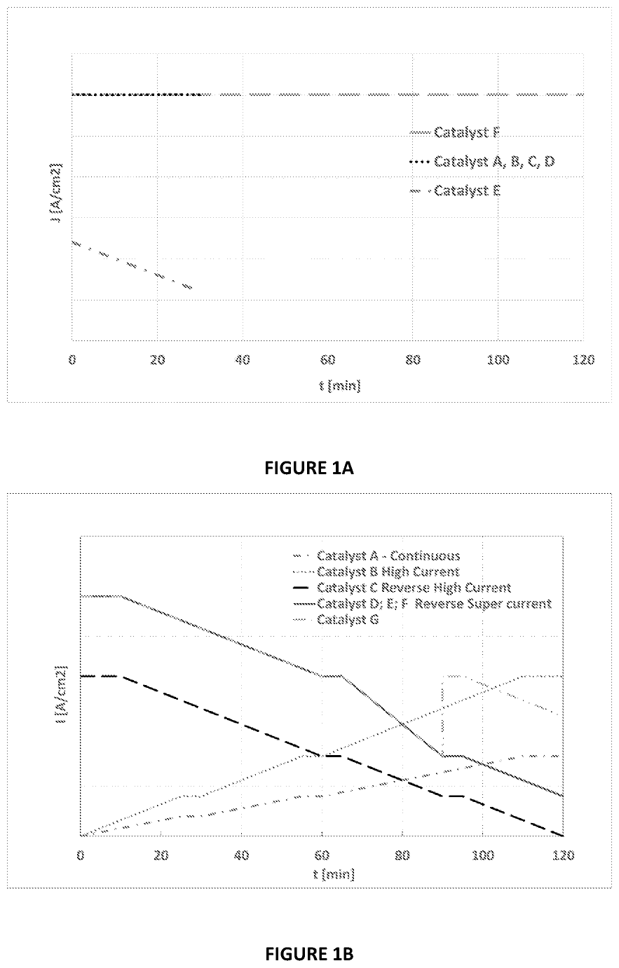

In some examples of the presently disclosed subject matter, the decreasing current density in the second conditions is applied with at least one interval, wherein during the at least one interval a constant current density is applied. In other words, the decreasing current conditions is applied in a step-wise manner/profile (as illustrated in the non-limiting example of FIG. 1B).

In some examples of the presently disclosed subject matter, the decreasing current density in the second conditions is applied with at least two intervals (i.e. at least two sessions during which a constant current density is applied).

When there is more than one interval, the duration of the intervals may be the same or different. In some examples of the presently disclosed subject matter, the duration of an interval comprises several minutes, e.g. up to 15 minutes; at times, up to 10 minutes; at times up to 8 minutes; at times, for about 5 minutes (without being limited thereto).

In some examples of the presently disclosed subject matter, the process comprises activating the anode and the cathode before the exposure to the first electrolyte solution. Activation can be achieved by washing with a strong acid.

In some examples of the presently disclosed subject matter, the process comprises washing off the first electrolyte solution before exposure to the second electrolyte solution.

In some examples of the presently disclosed subject matter, the washing off of the first electrolyte solution before exposure to the second electrolyte solution is with a solution comprising deionized water and an alcohol. An examples of an alcohol used for washing off the electolyte solution, without being limited thereto, is isopropyl alcohol (IPA). In some examples of the presently disclosed subject matter, the washing at a water (DI) to IPA ratio of about 50:50. In some examples of the presently disclosed subject matter, the washing off is with an alcohol, e.g. IPA undiluted with water.

In some examples of the presently disclosed subject matter, the washing off of the second electrolyte solution before exposure to the outer coating solution is with a solution comprising deionized water and an alcohol. An examples of an alcohol used for washing off the electolyte solution of the second conditions, without being limited thereto, is isopropyl alcohol (IPA). In some examples of the presently disclosed subject matter, the washing before applying the outer coating is at a water (DI) to IPA ratio of about 50:50. In some examples of the presently disclosed subject matter, the washing off before applying the outer coating, is with an alcohol, e.g. IPA undiluted with water.

In some examples of the presently disclosed subject matter, after coating with the distal layer (or after the coating with the additional outer layer), the obtained catalyst is once again washed with an alcohol and/or alcohol:water solution as described above.

Without being limited thereto, any one of the following conditions can be applied in order to obtain a catalyst according to the present disclosure.
First condition comprising a constant current of between about 0.001 A/cm² and about 0.01 A/cm² for at least 60 minutes and second condition comprising a decreasing current density, decreasing, in intervals, from the constant current density to a current density of between about 0.001 A/cm² and 0.01 A/cm² for a period of between about 100 minutes and 160 minutes or 60 minutes and 140 minutes.
First condition comprising a decreasing current density from between about 0.1 A/cm² and about 0.005 A/cm² for at least 10 minutes and the second condition comprising a decreasing current density, decreasing, in intervals, to a current density of between about 0.001 A/cm² and 0.01 A/cm² for a period of between about 100 minutes and 160 minutes or 60 minutes and 140 minutes.
Second conditions comprising constant current density at density between 0.001 A/cm² and 0.01 A/cm² for 10 minutes followed by a decreasing current density (with or without intervals) with an overall decrease from a density within a range of between 0.1 A/cm² to 0.001 A/cm².
Outer coating conditions comprising a constant current density at the reached current density followed by decreasing current density (with or without intervals) with an overall decrease from a density within a range of between 0.1 A/cm² to 0.001 A/cm².

Further, the present disclosure provides a system for releasing hydrogen gas from hydrogen carrier, the system comprises a reaction chamber carrying one or more catalysts of a type disclosed herein, a liquid inlet port connectable to a hydrogen carrier source and a gas outlet port for removing hydrogen gas released within the reaction chamber.

In some examples of the presently disclosed subject matter, the reaction chamber comprises a liquid outlet configured for removing spent hydrogen carrier liquid from the chamber.

The hydrogen carrier may be any one of various materials that are soluble in one or more selected liquid carriers (e.g. water) and can release hydrogen gas in response to interaction with the catalyst. Various hydrogen carrier materials may include metal hydrides, and in some examples of the presently disclosed subject matter, include metal borohydrides. In this connection, metal borohydrides may include any chemical compound described by formula M¹-BH₄, where M¹ represents one or more metals selected from column I or II of the periodic table of elements, or alloys of metals selected from column I or II of the periodic table of elements. For example, metal M¹ may include any of Li, Na, K, Rb, Cs, Fr, Mg, Ca, and Be. Alternatively, metal M¹ may also include Al, Ti, or other suitable metals. In some further examples, metal M¹ may include an alloy of one or more of metals selected from: Li, Na, K, Rb, Cs, Fr, Mg, Ca, Be, Al, Ni, and Ti.

In some examples of the presently disclosed subject matter, the hydrogen carrier includes K—BH₄.

The hydrogen carrier may be provided in solid form, being powder, flakes, crystals, or a bulk material. Yet, in operation, the hydrogen carrier source is mixed with a liquid carrier to provide hydrogen liquid carrier.

The liquid carrier may be any liquid material suitable for dissolving the hydrogen carrier. In typical examples, the liquid carrier is water, and preferably deionized (DI) water.

Further, in operation, the system utilizes the hydrogen liquid carrier comprising for example, M¹-BH₄, as the hydrogen carrier, which react together within in the reaction chamber comprising the catalyst, to produce hydrogen gas (H₂) and spent carrier liquid comprising M¹BO₂.

All definitions, as defined and used herein, should be understood to control over dictionary definitions, definitions in documents incorporated by reference, and/or ordinary meanings of the defined terms.

As used herein, the indefinite articles “a”, “an” and “the” include singular as well as plural references unless the context clearly dictates otherwise. In other words, unless clearly indicated to the contrary, these should be understood to mean “at least one.”.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some examples of the presently disclosed subject matter, the term “about” refers to +10%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements.

Further, as used herein, the term “comprising” is intended to mean that a described product and/or process includes the recited element, but not excluding other elements. The term “consisting essentially of” is used to define a described product and/or process which includes the recited elements but exclude other elements that may have an essential significance on the described product and/or process. “Consisting of” shall thus mean excluding more than trace elements of other elements. Embodiments defined by each of these transition terms are within the scope of this invention.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the present disclosure, the invention may be practiced otherwise, in a myriad of possible ways, than as specifically described hereinbelow.

### DETAILED DESCRIPTION OF NON-LIMITING EXAMPLES

The catalysts prepared in the following non-limiting examples comprise a substrate, at least one first metal coating layer on top of the substrate (referred to herein as the undercoat or the proximal layer) and at least one second metal coating layer on top of the first layer (referred to herein as the overcoat or the distal layer).

### Catalyst Preparation

### Substrate Preparation:

A stainless steel 316L coated with 5-50 μm Cu and 5-50 μm Ni and having dimensions of ×700 mm×10 mm×1.2 mm (Height/Width/Depth) was used as a substrate (as the cathode). The substrate was immersed for 40 minutes, at room temperature, in a degreasing solution comprising sodium hydroxide (NaOH, 0.05-0.5 mol/L), sodium carbonate decahydrate (Na₂CO₃*10H₂O, 0.05-0.5 mol/L) and trisodium phosphate (Na₃PO₄, 0.25 mol/L), followed by rinsing with deionized (DI) water. The degreased substrate was immersed for 15 minutes at room temperature in a pickling solution of 10 wt % H₂SO₄ and rinsed again with deionized (DI) water.

### MMO/Ti Mesh Activation:

A Mixed Metal Oxide (MMO) Activated Ti Anodes/Electrodes (MMO/Ti Mesh anode) was washed by DI water followed by immersion in the pickling solution as described above, for 10 minutes, and further rinsing again with DI water.

### Electrolyte Solution Preparation:

Two Electrolyte solutions were prepared, Electrolyte A solution and Electrolyte B solution, as follows:
Electrolyte A solution was prepared by dissolving about 25 g of CoCl₂·6H₂O, about 40 g of NaH₂PO₂·H₂O, about 45 g of NH₂CH₂COOH, and 35 g of H₃BO₃ in 1 L of DI water and adjusting the pH of the solution to pH of between 4 and 6 with NaOH 40 wt %.
Electrolyte B solution was prepared by dissolving 25 g of CoCl₂·6H₂O, 40 g of NaH₂PO₂·H₂O, and 45 g of NH₂CH₂COOH in 1 L of DI water. and adjusting the pH of the solution to be between 8 and 10 with NaOH 40 wt %.
Electrolyte C solution was prepared by dissolving 25 g of CoCl₂·6H₂O, 120 g of NaH₂PO₂·H₂O, and 45 g of NH₂CH₂COOH in 1 L of DI water. and adjusting the pH of the solution to be between 8 and 10 with NaOH 40 wt %.

The electrolyte solution volume ratio was 40 cm²:1 Liter electrolyte (ratio of cathode area to the volume of the plating bath).

### Deposition of Proximal Layer Followed by Distal Layer

### Proximal Layer Deposition Under Acidic Conditions:

In a double walled beaker the substrate and the MMO/Ti Mesh were placed near the sidewall of the beaker and immersed in Electrolyte A solution, at 50° C., followed by connecting the substrate and the MMO/Ti Mesh anodes to a current power source, the substrate to the (−) terminal and the anode to the (+) terminal.

While being immersed in Electrolyte A solution, a first deposition profile was applied according to Table 1 below until the undercoat (proximal) layer was applied onto the substrate according to the profiles schematically illustrated in FIG. 1A.

At the end of the deposition of the undercoat layer, Electrolyte A solution was washed off using DI water and isopropyl alcohol (IPA) (50:50), followed by washing with IPA and drying at room temperature.

Distal layer deposition under alkaline conditions: The MMO/Ti Mesh from the first deposition step was cleaned/re-activated by immersion in deionized (DI) water, followed by immersion in the pickling solution for 10 minutes, and rinsing with deionized (DI) water.

In the double walled beaker, the first-layer coated substrate/cathode and the MMO/Ti Mesh/anode were immersed in Electrolyte B solution and connected with copper wires to a current power source, the substrate to the (−) terminal and the anode to the (+) terminal. While being immersed in Electrolyte B solution, a second deposition profile was applied according to Table 1 below and as schematically illustrated in FIG. 1B until the overcoat layer was applied onto the undercoat layer.

At the end of the deposition of the overcoat layer, Electrolyte B solution was washed off using DI water and isopropyl alcohol (IPA) (50:50), followed by washing with IPA and drying at room temperature.

Outer layer deposition under alkaline conditions: the deposition of an outer layer with Electrolyte C was performed in the same manner as with depositing the distal layer, after washing Electrolyte B, as noted above.

TABLE 1
Deposition profiles of Catalyst A-Catalyst G
Catalyst A

| | |
|---|---|
| Proximal | Constant current of between 0.001 A/cm² and 0.01 A/cm² |
| | for 30 min |
| Distal | increasing continuous current density for 25 minutes, |
| | followed by constant current density at the reached current density |
| | for 5 minutes; |
| | further increasing continuous current density for 25 minutes, |
| | followed by constant current density at the reached current |
| | density for 5 minutes. |
| | further increasing continuous current density to reach a density |
| | of up to 0.01 A/cm² for 50 minutes, followed by constant |
| | current density at the reached current density for 10 minutes. |

Catalyst B

| | |
|---|---|
| Proximal | Constant current density of between about 0.001 A/cm² |
| | and about 0.01 A/cm² for 30 min |
| Distal | increasing continuous current density for 25 minutes, followed by |
| | constant current density at the reached current density for 5 |
| | minutes; |
| | further increasing continuous current density for 25 minutes, |
| | followed by constant current density at the reached current |
| | density for 5 minutes. |
| | further increasing continuous current density to reach a density of |
| | up to 0.02 A/cm² for 50 minutes, followed by constant |
| | current density at the reached current density for 10 minutes. |

Catalyst C

| | |
|---|---|
| Proximal | Constant current density of between 0.001 A/cm² and 0.01 A/cm² |
| | for 30 min |
| Distal | Constant current density for 10 minutes, followed by continuous |
| | decreasing current density to not less than 0.005 A/cm² |
| | for 50 minutes. |
| | Constant current density at the reached current density for 5 |
| | minutes, followed by decreasing continuous current density to not |
| | less than 0.003 A/cm² for 25 minutes. |
| | Constant current density at the reached current density for 5 |
| | minutes, followed by decreasing continuous current density to 0 |
| | A/cm² for 25 minutes. |

Catalyst D

| | |
|---|---|
| Proximal | Constant current density of between 0.001 A/cm² and 0.01 A/cm² |
| | for 30 min |
| Distal | Constant current density of between about 0.003 A/cm² and about |
| | 0.01 A/cm² for 10 minutes, followed by decreasing continuous |
| | current density to not less than 0.01 A/cm² for 50 minutes. |
| | Constant current density at the reached current density for 10 |
| | minutes, followed by decreasing continuous current density to a |
| | current density not less than 0.005 A/cm² for 20 minutes. |
| | Constant current density at the reached current density for 10 |
| | minutes, followed by decreasing continuous current density to a |
| | current density of not less than 0.001 A/cm² for 20 minutes |

Catalyst E

| | |
|---|---|
| Proximal | Continuous decreasing current density from about 0.05 A/cm² |
| | to 0.005 A/cm² for 30 min |
| Distal | Constant current density at a current density between about 0.03 |
| | A/cm² and about 0.01 A/cm² for 10 minutes, followed by |
| | decreasing continuous current density from the reached current |
| | density to a current density of not less than 0.01 A/cm² |
| | for 50 minutes. |
| | Constant current density at the reached current density for 10 |
| | minutes, followed by decreasing continuous current density to not |
| | less than 0.005 A/cm² for 20 minutes. |
| | Constant current density at the reached current density for 10 |
| | minutes, followed by decreasing continuous current density to not |
| | less than 0.001 A/cm² for 20 minutes. |

Catalyst F

| | |
|---|---|
| Proximal | Constant current density of between 0.001 A/cm² and 0.01 A/cm² |
| | for 120 min |
| Distal | Constant current density at a current density between 0.03 A/cm² |
| | and 0.001 A/cm² for 10 minutes, followed by decreasing |
| | continuous current density to not less than 0.01 A/cm² |
| | for 50 minutes. |
| | Constant current density at the reached current density for 10 |
| | minutes, followed by decreasing continuous current density to not |
| | less than 0.005 A/cm² for 20 minutes. |
| | Constant current density at the reached current density for 10 |
| | minutes, followed by decreasing continuous current density to not |
| | less than 0.001 A/cm² for 20 minutes |

Catalyst G

| | |
|---|---|
| Proximal | Constant current density of between 0.001 A/cm² and 0.01 A/cm² |
| | for 120 min |
| Distal | Constant current density at a current density between about 0.03 |
| | A/cm² and about 0.01 A/cm² for 10 minutes, followed by |
| | decreasing continuous current density from the reached current |
| | density to a current density of not less than 0.01 A/cm² for 50 |
| | minutes. |
| | Constant current density at the reached current density for 10 |
| | minutes, followed by decreasing continuous current density to not |
| | less than 0.005 A/cm² for 20 minutes. |
| | Constant current density at the reached current density for 10 |
| | minutes, followed by decreasing continuous current density to not |
| | less than 0.001 A/cm² for 20 minutes. |
| Outer | Constant current density at the reached current density for 10 |
| layer | minutes, followed by decreasing continuous current density to not |
| | less than 0.001 A/cm² for 20 minutes. |

### Results

Each of the prepared catalysts was evaluated using scanning electron microscope (SEM) and 3D profilometer. SEM images where collected using TESCAM VEGA 4 @ 5 eV in resolution mode. 3D profilometer images were collected using FILMETRICS 3D Profilometer using ×20 objective.

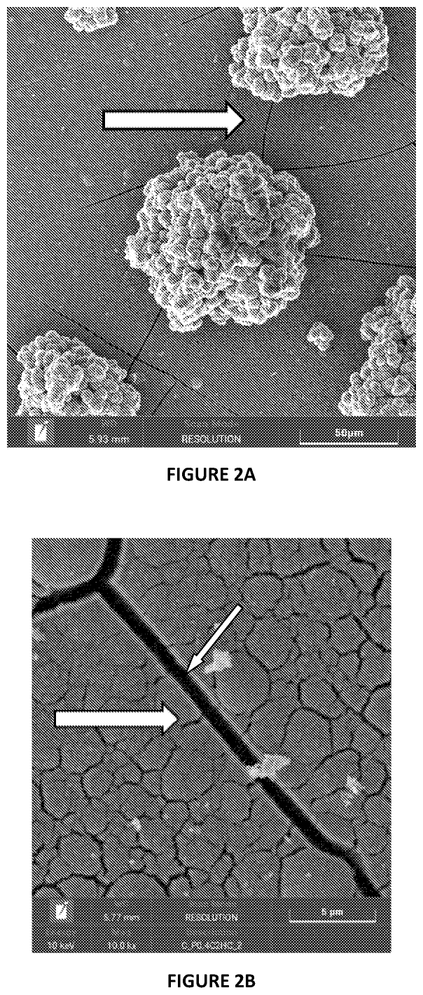

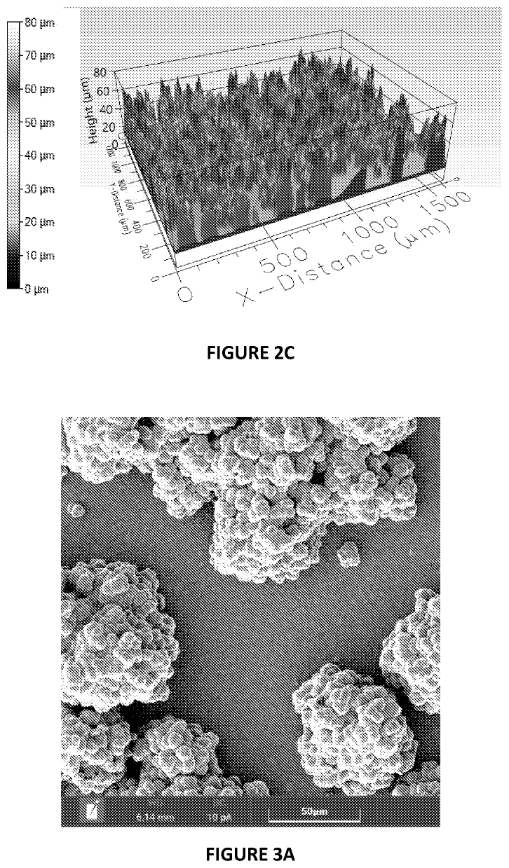

FIGS. 2A and 2B are SEM images of Catalyst B at two magnifications of ×1,000 and ×10,000, respectively. It can be seen that the Catalyst B did not provide full coating of the substrate, and two magnitudes of cracks are observed, micro-cracks, such as the crack identified in FIG. 2B by arrow M) and smaller, nano cracks such as the crack identified in FIG. 2B by arrow N.

Without being bound by theory it is assumed that the micro-cracks were formed due to a massive compressions stress induced at the beginning of the deposition of Electrolyte B solution (the distal layer) and a low tensile stress. As the current density increases, the tensile stress increases as well as causing widening of these cracks during the growth evolution of the layer. The nano-cracks formation can be explained due to hydrogen formation during the deposition.

FIG. 2C is a 3D profilometer image of Catalyst B showing the gaps of more than 100 micron between deposited material, i.e. that the layer is not uniform and large gaps between the particles on the distal layer are formed.

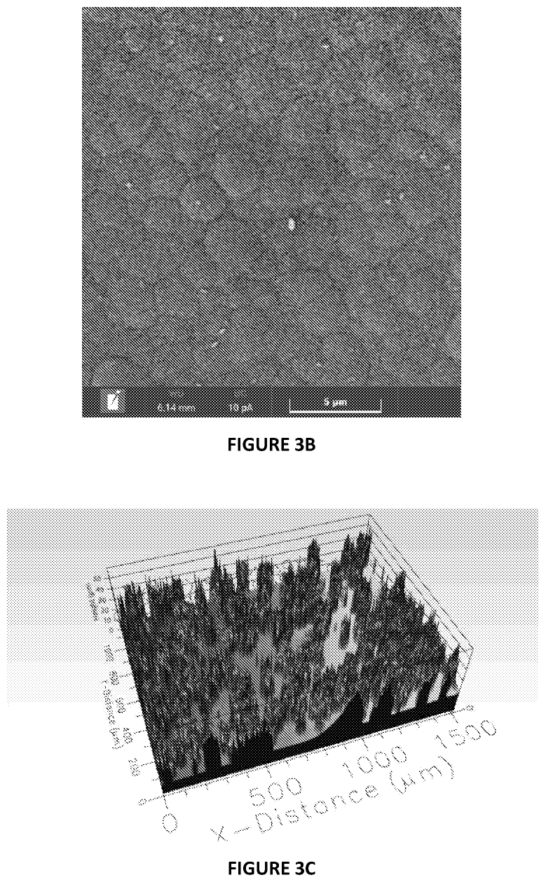

FIGS. 3A and 3B are SEM images of Catalyst C at two magnifications of ×1,000 and ×10,000, respectively. FIG. 3A shows that although there is no full coverage by the layer, there are no cracks between the particles. This is further reflected in FIG. 3B showing an arbitrary area having no visible cracks, i.e. being “crack free”. When considering the 3D profilometer image of FIG. 3C it is clear that coating protocol of Catalyst C is unable to provide full coverage of the substrate, with micro-range gaps between deposited matter.

Without being bound by theory, it is assumed that the high current density at the beginning of the alkaline deposition stage (the distal layer), induced low compressive stresses and therefore no micro-cracks were formed. At the same time, it was observed that high tensile stresses assisted in the spreading of the layer Further as the current density decreased, the high compressive stresses seemed to have eliminated nano cracks formation during hydrogen release and the lower tensile stresses do not expand existing cracks as they are eliminated at the initial formation stage of the layer.

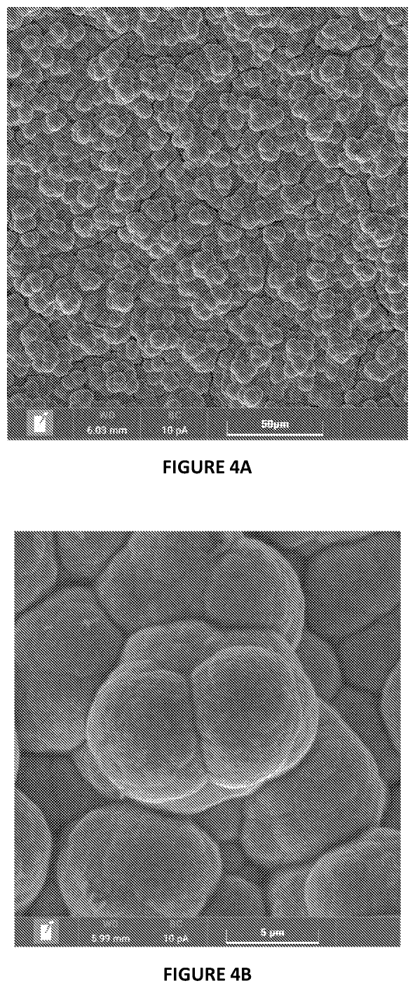

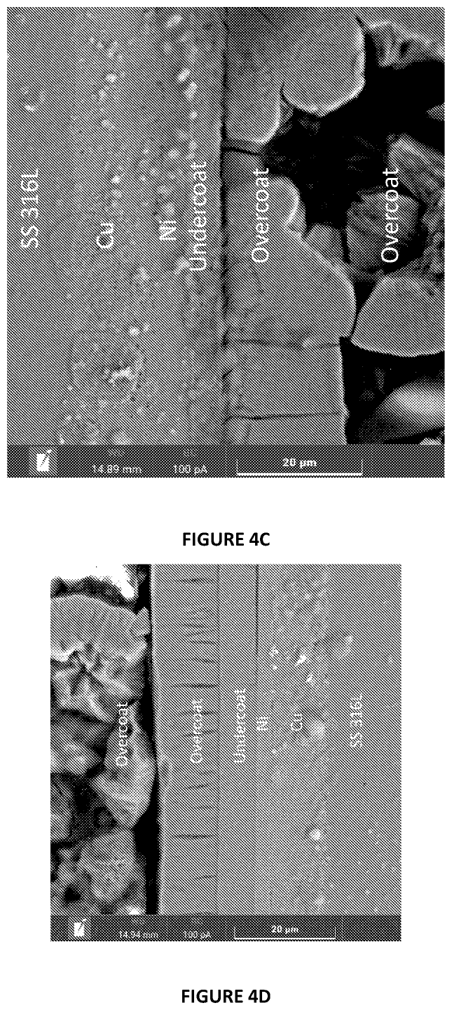

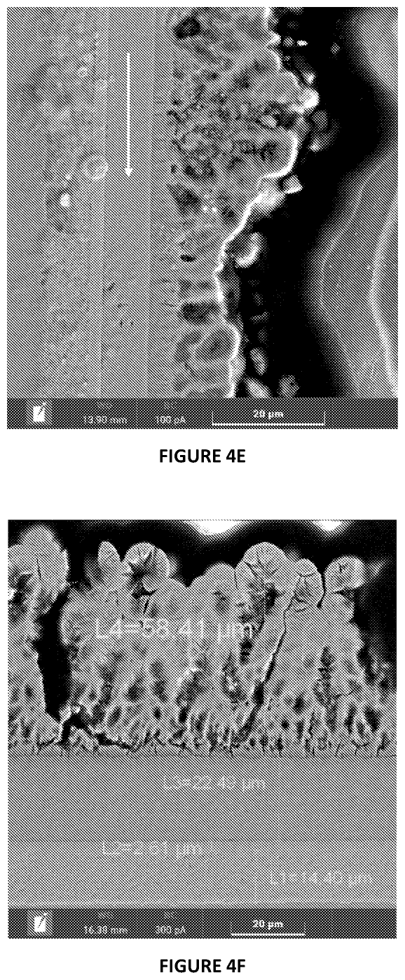

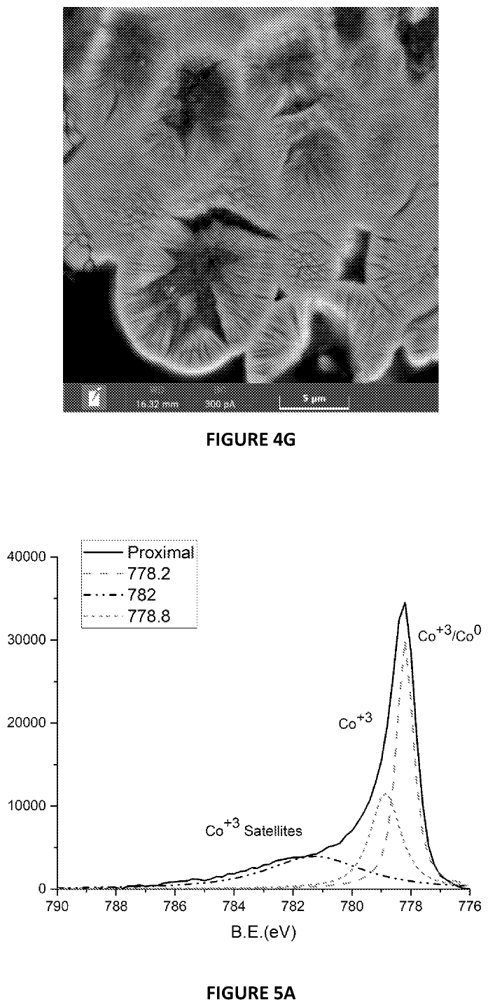

FIGS. 4A and 4B provide SEM images of Catalyst F, at a magnification of ×1,000 & ×10000, respectively, showing full coverage of the substrate.

Cross sectional views of Catalysts D-G are provided in FIGS. 4C-4F, exhibiting a core-shell coating morphology with a porous core of the layer distal from the substrate. The coating of Catalysts D, E, F and G provided a full and uniform coverage over the substrate, while being different one from the other mainly in the thickness of the proximal layer. Catalyst G exhibit additional thin, porous layer, less than 1 μm.

Without being bound by theory, and as will be further discussed below, it is believed that the porosity of the distal layer increases the surface area available for catalysis and thereby improved catalytic activity of Catalyst F.

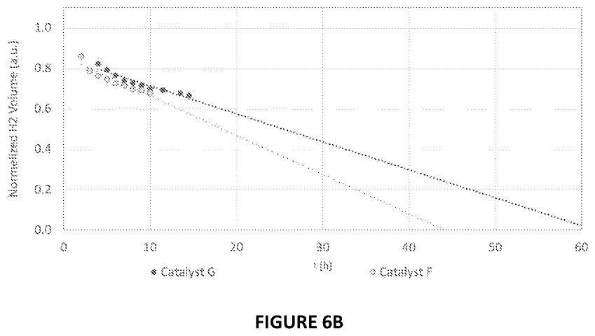

Further, without being bound by theory, it is believed that the additional outer coating over the distal layer even at less than 1 μm cross sectional dimension (thickness) significantly increased durability of the catalyst, as shown in FIG. 6B.

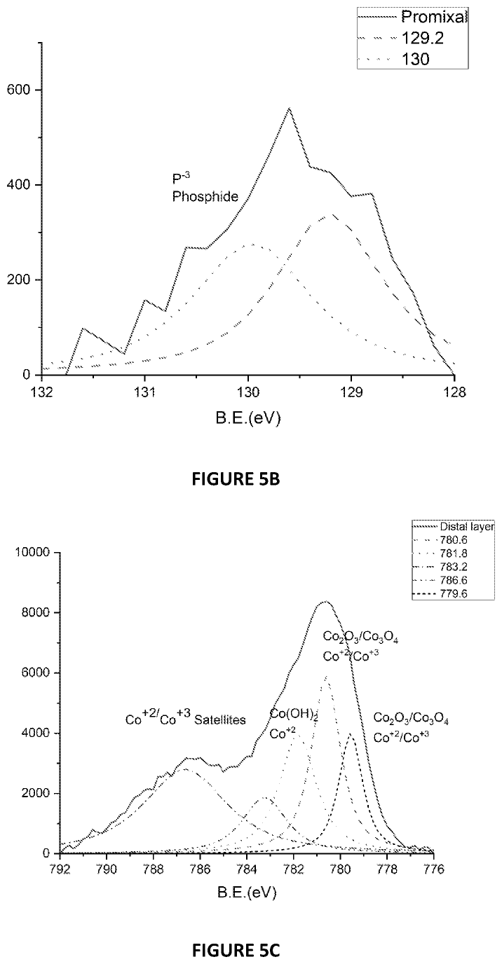

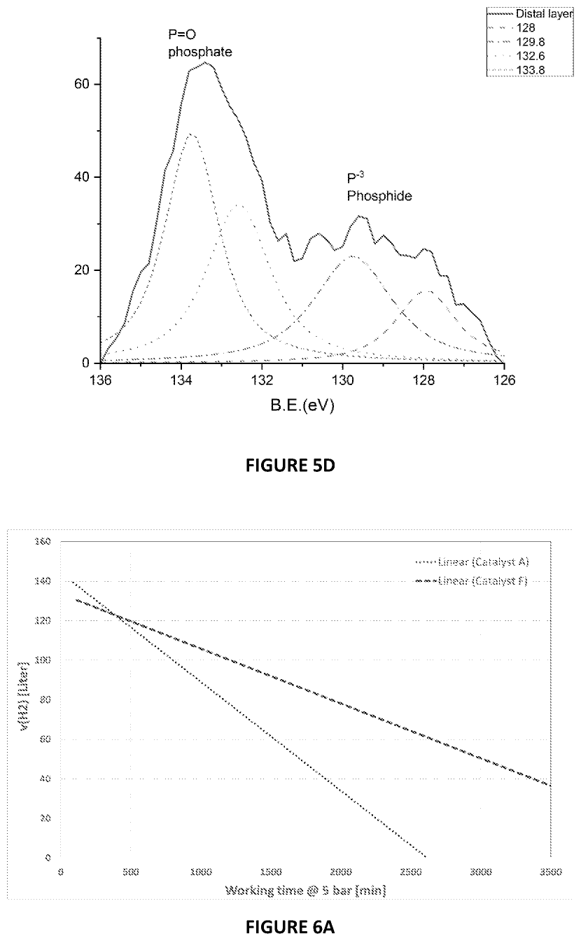

In addition, the surface area composition of Catalyst F was determined using X-ray Photoelectron Spectroscopy (XPS) in the proximal layer (FIGS. 5A-5B) and distal layer (FIGS. 5C-5D).

Specifically, FIG. 5A shows that the proximal layer comprises a single cobalt type, namely CoP (cobalt phosphide) and thus is considered a non-active layer, while the distal layer comprises different cobalt complexes, i.e. in addition to metal cobalt (Co—P), a mixture of the general formula CoPOx (x being any value between 2 and 4), as shown in FIG. 5C.

FIG. 5B shows that the proximal layer comprises mainly P⁻³ phosphide while the distal layer comprises a combination of phosphate and P⁻³ phosphide (FIG. 5D).

### Mechanical Stability (Durability)

The mechanical stability of Catalyst F was examined using a Hydrogen-on-Demand system under the conditions described above, yet, at elevating temperatures, starting from room temperature and heating using exothermic heat released from the hydrogen production. This procedure simulated “cold start” operating system conditions. FIGS. 6A-6B show durability of Catalysts A, F and G.

It was found that catalyst F maintained its functionality (was durable) after a period of several months of operation.

In addition, it was found that the addition of an outer coating comprising a thin porous layer (in this example, of Electrolyte C) and having a thickness of less than 1 μm was sufficient to increase durability of the catalyst, as compared to catalyst F. This suggests, without being limited thereto, that an additional outer porous layer, even a thin one, can improve the functionality of the catalyst.

1. A catalyst comprising a conductive substrate coated by at least two layers including a proximal layer and a distal layer,
wherein said proximal layer comprises a proximal metal composition and said distal layer comprise a distal metal composition, the proximal metal composition being different from the distal metal composition;
wherein said proximal metal composition comprises a metallic M and said distal metal composition comprise a combination of two or more different metal complexes, each having a formula MₓL_{y}, wherein
M, which may be the same or different in said two or more metal complexes, represents a metal atom;
L, which may be the same or different in said two or more metal complexes, represents a moiety comprising at least one atom selected from the group consisting of oxygen (O), phosphorous (P), boron (B) and nitrogen (N);
x represents any value between 1 and 6; and
y represents any value between 1 and 6; and
wherein said metal atom of metallic M and said metal atom in MₓL_{y} may be the same or different metal atom.

2. The catalyst of claim 1, wherein said conductive substrate comprises a conductive material selected from the group consisting ferrous (Fe), Fe alloy, nickel (Ni), cobalt (Co), Ni/Co alloy, copper (Cu), carbon black and carbon paper and any combinations of same.

3. (canceled)

4. The catalyst of claim 1, wherein said M is a metal selected from the group consisting of cobalt (Co), nickel (Ni), iron (Fe), ruthenium (Ru), rhodium (Rh), palladium (Pd), platinum (Pt), titanium (Ti), vanadium (V), manganese (Mn), and molybdenum (Mo).

5. (canceled)

6. The catalyst of claim 1, wherein more than 50% of said proximal metal composition comprises metallic M.

7. The catalyst of claim 6, wherein said proximal metal composition comprise a metal complex of said formula MₓL_{y}.

8. The catalyst of claim 1, wherein said distal metal composition comprises metallic M.

9. The catalyst of claim 1, wherein the metallic M in said proximal metal composition comprises CoP.

10. The catalyst of claim 1, wherein the metal atom in said formula MₓL_{y} is cobalt.

11. The catalyst of claim 1, wherein said distal metal composition comprise a cobalt complex selected from the group consisting CoO, Co₂O₃, Co₃O₄, CoOOH, Co(OH)₂, CoPO₂, CoPO₄.

12. The catalyst of claim 11, wherein said distal metal composition comprises CoP.

13. The catalyst of claim 1, comprising an outer layer coating over said distal layer, the outer layer comprising a same or different composition than that of the distal metal composition.

14. The catalyst of claim 1, wherein at least one of the following is fulfilled:
said proximal layer is lacking visible gaps as determined from a cross sectional view of the catalyst under a scanning electron microscope (SEM) with a magnification of 1,000 or more;
said distal layer is a porous layer as determined from a cross sectional view of the catalyst under a scanning electron microscope (SEM) with a magnification of 1,000 or more; or
said outer layer comprises a cross sectional dimension of less than 1 μm.

15.-17. (canceled)

18. The catalyst of claim 1, characterized by at least one of the following:
(a) the catalyst has catalytic activity when determined in a Hydrogen On Demand release system operated under the following conditions: 5M KBH₄ in H₂O; or (b) the catalyst maintains integrity after hydrogen release for a period at least 3 months, said integrity being determined when having less than 10% reduction of the catalyst's cross-sectional dimension after said period.

19. (canceled)

20. A process for producing a catalyst, the process comprising:
(a) providing an electrochemical cell comprising a cathode and an anode, each being connected to an electrical source, said cathode comprising a conductive substrate;
(b) expositing said electrochemical cell to a first electrolyte solution comprising a metal M salt and a counter ion salt, said first electrolyte solution having an acidic pH; and operating said electrochemical cell under first conditions that cause deposition of a proximal layer over said conductive substate, the proximal layer comprising at least metallic M;
(c) expositing said electrochemical cell having said proximal layer on said substrate, to a second electrolyte solution having an alkaline pH and comprising a metal salt and a counter ion salt, which may be the same or different from the metal salt and the counter ion salt of said first electrolyte solution; and operating the electrochemical cell under second conditions that cause deposition of a distal layer over said proximal layer, the distal layer coating comprising a combination of two or more different metal complexes, each having a formula MₓL_{y}, wherein
M, which may be the same or different in said two or more metal complexes, represents a metal atom;
L, which may be the same or different in said two or more metal complexes, represents a moiety comprising at least one atom selected from the group consisting of oxygen (O), phosphorous (P), boron (B) and nitrogen (N);
x represents any value between 1 and 6; and
y represents any value between 1 and 6;
said catalyst comprises said conductive substrate coated with said proximal layer and said distal layer.

21. The process of claim 20, wherein said conductive substrate comprises a conductive material selected from the group consisting ferrous (Fe), Fe alloy, nickel (Ni), cobalt (Co), Ni/Co alloy, copper (Cu), carbon black and carbon paper and any combinations of same.

22. (canceled)

23. The process of claim 20, wherein said metal M salt in said first electrolyte solution and in said second electrolyte solution can be the same or different and comprises a metal selected from the group consisting of cobalt (Co), nickel (Ni), iron (Fe), ruthenium (Ru), rhodium (Rh), palladium (Pd), platinum (Pt), titanium (Ti), Vanadium (V), manganese (Mn), and Molybdenum (Mo).

24. The process of claim 23, wherein said metal M is cobalt.

25. (canceled)

26. The process of claim 20, wherein said counter ion salt in said first electrolyte solution and said second electrolyte solution is a hypophosphite salt.

27. (canceled)

28. The process of claim 20, wherein said first electrolyte solution comprises at least one weak acid and said first electrolyte solution and/or said second electrolyte solution comprises a complexant.

29.-37. (canceled)

38. The process of claim 20, wherein said first conditions comprise operating said electrochemical cell under a decreasing current density, with optionally at least one interval, wherein during said at least one interval a constant current density is applied.

39.-48. (canceled)

49. A system for releasing hydrogen gas from hydrogen carrier, the system comprises a reaction chamber carrying one or more catalysts according to claim 1, a liquid inlet port connectable to a hydrogen carrier source and a gas outlet port for removing hydrogen gas released within the reaction chamber.

50. (canceled)
